(19) United States
(12) Patent Application Publication
(10) Pub. No.: US 2013/0024288 A1
(43) Pub. Date: Jan. 24, 2013

(54) SYSTEM AND METHOD FOR CREATING MULTIMEDIA RENDEZVOUS POINTS FOR MOBILE DEVICES

(71) Applicant: Joel Espelien, Mercer Island, WA (US)

(72) Inventor: Joel Espelien, Mercer Island, WA (US)

(21) Appl. No.: 13/595,472

(22) Filed: Aug. 27, 2012

Related U.S. Application Data
(63) Continuation of application No. 11/973,477, filed on Oct. 9, 2007.

(51) Int. Cl. H04W 4/02; G06Q 30/02

(52) U.S. Cl. 705/14.64; 455/414.1

(57) ABSTRACT

Systems and methods create multimedia rendezvous points for mobile devices. The mobile devices access digital media and/or a rendezvous identification (RID) for a rendezvous point of the digital media via a server and/or a network. The mobile devices connect to the rendezvous point via the RID of the digital media for communicating with each other. The mobile devices connect to and/or communicate with each other at the rendezvous point without disrupting consumption of the digital media. The rendezvous points may have subgroups which are based on attributes of the users, the mobile devices and/or the digital media. The users of the mobile devices create a private rendezvous point and/or a private RID which is accessible via an invitation and/or is based on the attributes of the users, the mobile devices and/or the digital media.

This application is a continuation application of and claims the benefit of U.S. application Ser. No. 11/973,477 filed Oct. 9, 2007 and further claims the benefit of U.S. Provisional Application Ser. No. 60/851,355 filed Oct. 12, 2006.

### BACKGROUND OF THE INVENTION

The present invention generally relates to a system and a method for creating multimedia rendezvous points for mobile devices. More specifically, the present invention relates to a system and a method for creating multimedia rendezvous points for mobile devices which may access and/or may consume digital media via a data communication network. The system and the method may connect the mobile devices at a multimedia rendezvous point to transmit communications during consumption of the digital media by the mobile devices. The mobile devices may access an electronic program guide of a content provider to select the digital media and/or to access a rendezvous identification for connecting to the multimedia rendezvous point for the digital media. The rendezvous identification may be embedded within the metadata of the electronic program guide for accessing the rendezvous identification via the mobile devices. In an embodiment, the mobile devices may access a second server via a data communication network to access the rendezvous identification for connecting to the multimedia rendezvous point for the digital media. The rendezvous identification may be an internet address, a worldwide web location, a uniform resource locator and/or the like.

The mobile devices may connect to and/or may access the multimedia rendezvous points for the digital media with consumption of the digital media via the data communication network and the rendezvous identification. After connecting to the multimedia rendezvous point and initiating consumption of the digital media by the mobile devices, users of the mobile devices may communicate during consumption of the digital media via the mobile devices. The mobile devices may transmit communications with each other via the multimedia rendezvous point and/or the data communication network without terminating consumption of the digital media by the mobile devices. The communications between the mobile devices may be, for example, text-based communications, voice-based communications, video-based communications and/or the like. The multimedia rendezvous point may have one or more subgroups for connecting one or more mobile devices at the multimedia rendezvous point in a subgroup based on an attribute of the users, of the mobile devices and/or of the digital media. Advertisements may be transmitted to and/or may be displayed by the mobile devices within the subgroup and/or at the multimedia rendezvous point. A user of a mobile device may create a private subgroup within a private multimedia rendezvous point to invite other users to join and/or to access for communicating with other users within the private subgroup within the private multimedia rendezvous point.

It is generally known, for example, that a content provider broadcasts and/or transmits media content to an audience via a television set over a radio network, a cable television network and/or a satellite network. The media content may be a performance, such as, for example, a sporting competition, a television program, a cable television program, a performing acts program and/or the like. Each consumer within the audience may view and/or may consume the media content via the television set but may be isolated from, may be disconnected from and/or may be separated from other consumers within the audience of the content provider.

Traditionally, the consumer may access an electronic program guide via a set-top box connected to the television set to determine and/or to identify a description of the media content available for consumption by the audience from the content provider. The consumer may select and/or may schedule to view and/or to consume the media content based on the description of the media content accessible via the electronic program guide. During consumption of the media content by the audience, each consumer within the audience observes, lives and/or encounters an experience by viewing and/or by consuming the media content via the television set. However, more than one consumer within the audience may desire to communicate with other consumers of the media content to share the experience of viewing and/or of consuming the media content.

Moreover, it is generally known that consumers of the media content may communicate with other consumers of the media content via a telephone and/or a computer terminal to share the experience of viewing and/or of consuming the media content. The consumers may verbally discuss the media content and/or the experience of the media content with other consumers of the media content via the telephone. Alternatively, the consumers may transmit a text-based message to other consumers of the media content for describing the media content and/or the experience of the media content with other consumers of the media content via the instant messaging application, an electronic mail application and/or a text messaging application over the computer terminal. Additionally, consumers of the media content may communicate the experience of the media content to a performer associated with the media content and/or to a content provider of the media content via a text messaging application of a cellular telephone. However, the consumer of media content must observe the media content displayed on the television set and must operate the telephone, the computer terminal and/or the cellular telephone to transmit the communications describing the experience of the media content with other consumers of the media content. As a result, transmissions of the communications describing the experience of the media content between the consumers of the media content may affect, may alter and/or may degrade the experience of the media content by the consumers of the media content.

Furthermore, it is generally known, for example, that consumers of media content may access a bulletin board system via the computer terminal and a data communication network, such as, for example, an Internet, a worldwide web and/or the like. The consumers of the media content publish, post and/or display communications on an online forum and/or an online message board via the bulletin board system. As a result, the consumers of the media content may share the communications associated with the media content, the performers of the media content and/or the experience of the media content via the online forum and/or the online message board over the bulletin board system. However, the consumers of the media content are incapable of transmitting the communications associated with the experience of the media content to other consumers of the media content during the consumption of the media content with the television set. As a result, the consumers of the media content are incapable of sharing the experience of the media content over the bulletin board system during consumption of and/or viewing of the media content with the television set.

A need, therefore, exists for a system and a method for creating multimedia rendezvous points for mobile devices. More specifically, a need exists for a system and a method for creating multimedia rendezvous points for mobile devices which may prevent consumers of digital media from being isolated and/or disconnected from other consumers of the digital media during consumption of the digital media.

Further, a need exists for a system and a method for creating multimedia rendezvous points for mobile devices which may allow consumers of digital media to share the experience of the digital media with other consumers of the digital media during consumption of the digital media. Still further, a need exists for a system and a method for creating multimedia rendezvous points for mobile devices which may allow consumption of digital media and transmission of communications between consumers via a rendezvous point and/or the mobile devices during the consumption of the digital media.

Moreover, a need exists for a system and a method for creating multimedia rendezvous points for mobile devices which may allow transmission and/or interaction between consumers of digital media during consumption of the digital media via communications, the mobile devices and/or a rendezvous point. Furthermore, a need exists for creating multimedia rendezvous points for mobile devices which may allow a consumer of digital media to consume the digital media with a mobile device and to transmit communications associated with the digital media to other consumers of the digital media via the mobile device.

### SUMMARY OF THE INVENTION

The present invention generally relates to a system and a method for creating multimedia rendezvous points for mobile devices. More specifically, the present invention relates to a system and a method for creating multimedia rendezvous points for mobile devices which may access digital media from a database of a content provider for consumption and/or for viewing of the digital media via the mobile devices. The mobile devices may access an electronic program guide of the content provider via a first server and/or a data communication network to select and/or to access the digital media from the database. The mobile devices may receive and/or may access a rendezvous identification for the digital media which may be embedded within the metadata for the digital media within the electronic program guide. In an embodiment, the mobile devices may access and/or may identify the rendezvous identification for the digital media via a second server and/or a data communication network.

The mobile devices may access a multimedia rendezvous point for the digital media to transmit communications between the mobile devices via the data communication network and the rendezvous identification. The mobile devices may transmit the communications via the multimedia rendezvous point for the digital media during consumption of and/or viewing of the digital media with the mobile devices. As a result, users of the mobile devices may share an experience of consuming and/or of viewing the digital media with other users which may be consuming the digital media. The multimedia rendezvous point may have one or more subgroups based on an attribute of the users, the mobile devices, the digital media and/or the experience of the digital media. Advertisements may be transmitted to the mobile devices within one or more subgroups or at the rendezvous point based on the attribute of the users, the mobile devices, the digital media and/or the experience of the digital media. Users may create a private rendezvous identification for identifying a private multimedia rendezvous point and/or a private subgroup within the multimedia rendezvous point.

To this end, a method for exchanging communications between a first mobile device and a second mobile device is provided. The method has the steps of: providing a database of digital media files wherein each digital media file in the database has metadata wherein a content provider provides the database; creating a plurality of rendezvous points wherein each rendezvous point is an online location accessible to the first mobile device and the second mobile device; assigning to each digital media file in the database one of the rendezvous points of the plurality of rendezvous points wherein a first rendezvous point is assigned to a first media file having first metadata; inserting a uniform resource locator into the metadata of each digital media file in the database wherein each uniform resource locator identifies the online location of the rendezvous point assigned to the digital media file and further wherein a first uniform resource locator which identifies the first rendezvous point is inserted into the first metadata of the first media file; transmitting the first media file and the first metadata to the first mobile device wherein the content provider transmits the first media file and the first metadata to the first mobile device; connecting the first mobile device to the online location of the first rendezvous point wherein the first mobile device uses the first uniform resource locator to connect to the online location of the first rendezvous point wherein the first mobile device is connected to the online location of the first rendezvous point while consuming the first media file; transmitting the first media file and the first metadata to the second mobile device wherein the content provider transmits the first media file and the first metadata to the second mobile device; connecting the second mobile device to the online location of the first rendezvous point wherein the second mobile device uses the first uniform resource locator to connect to the online location of the first rendezvous point wherein the first mobile device is connected to the online location of the first rendezvous point while consuming the first media file; and exchanging communications between the first mobile device and the second mobile device via the first rendezvous point wherein the first mobile device and the second mobile device exchange the communications while consuming the first media file.

In an embodiment, the method has the step of displaying a notification on the first mobile device wherein the notification indicates to a user of the first mobile device that the first rendezvous point is accessible.

In an embodiment, the method has the step of displaying a notification on the first mobile device. The notification indicates to a user of the first mobile device that the first rendezvous point is accessible, and the notification is displayed prior to consumption of the media file by the first mobile device.

In an embodiment, the method has the step of displaying a notification on the first mobile device wherein the notification indicates to a user of the first mobile device that the first rendezvous point is accessible wherein the notification is a pop-up window.

In an embodiment, the method has the step of exchanging a text communication between the first mobile device and the second mobile device via the first rendezvous point wherein the first mobile device and the second mobile device exchange the text communication while consuming the first media file.

In an embodiment, the method has the step of exchanging an audio communication between the first mobile device and the second mobile device via the first rendezvous point wherein the first mobile device and the second mobile device exchange the audio communication while consuming the first media file.

In an embodiment, the method has the step of exchanging a graphical communication between the first mobile device and the second mobile device via the first rendezvous point wherein the first mobile device and the second mobile device exchange the graphical communication while consuming the first media file.

In an embodiment, the method has the step of exchanging a audiovisual communication between the first mobile device and the second mobile device via the first rendezvous point wherein the first mobile device and the second mobile device exchange the audiovisual communication while consuming the first media file.

In an embodiment, the method has the step of exchanging a multimedia communication between the first mobile device and the second mobile device via the first rendezvous point wherein the first mobile device and the second mobile device exchange the communication while consuming the first media file.

In an embodiment, the communications share the media consumption experience of users of the mobile devices.

In an embodiment, the method has the steps of displaying a notification on the first mobile device wherein the notification indicates the existence of a subgroup of the first rendezvous point to a user of the first mobile device wherein the notification is displayed while the first mobile device is connected to the first rendezvous point; and presenting an option for the user to connect to the subgroup.

In another embodiment of the present invention, a method for exchanging communications between a first mobile device and a second mobile device is provided. The method has the steps of providing a database of digital media files wherein each digital media file in the database has metadata wherein a content provider provides the database; creating a first rendezvous point wherein the first rendezvous point is an online location accessible to the first mobile device and the second mobile device; assigning the first rendezvous point to a first media file of the database wherein the first rendezvous point has first metadata; inserting a first uniform resource locator (URL) into the first metadata of the first media file wherein the first uniform resource locator identifies the online location of the first rendezvous point; transmitting the first media file and the first metadata to the first mobile device wherein the content provider transmits the first media file and the first metadata to the first mobile device; connecting the first mobile device to the online location of the first rendezvous point wherein the first mobile device uses the first uniform resource locator to connect to the online location of the first rendezvous point wherein the first mobile device is connected to the online location of the first rendezvous point while consuming the first media file; connecting the second mobile device to the online location of the first rendezvous point wherein connection of the first and second mobile devices to the first rendezvous point allows the first and second mobile devices to exchange communications while the first mobile device consumes the first media file; displaying a notification on the first mobile device wherein the notification indicates to a user of the first mobile device that a subgroup of the first rendezvous point is available; connecting the first mobile device to the subgroup of the first rendezvous point in response to user input accepted by the first mobile device; and transmitting a communication wherein the first mobile device transmits the communication while the first mobile device is connected to the subgroup of the first rendezvous point and further wherein the second mobile device receives the communication if the second mobile device is also connected to the subgroup.

In an embodiment, the subgroup is created by a user of the second mobile device.

In an embodiment, the subgroup is based on a first user attribute and further wherein the connection of the first mobile device to the subgroup is based on a user of the first mobile device having the first user attribute.

In an embodiment, the method has the step of transmitting advertising media associated with the subgroup to the mobile devices connected to the subgroup and not transmitting the advertising media to mobile devices connected to the first rendezvous point which are not connected to the subgroup.

In an embodiment, the method has the step of transmitting advertising media associated with the subgroup to the mobile devices connected to the subgroup prior to consumption of the first media file by a user.

In an embodiment, the method has the step of transmitting advertising media associated with the subgroup to the mobile devices connected to the subgroup during consumption of the first media file by a user.

In an embodiment, the method has the step of transmitting advertising media associated with the subgroup to the mobile devices connected to the subgroup after consumption of the first media file by a user.

In an embodiment, the subgroup is associated with an age group wherein mobile devices are connected to the subgroup based on whether the users of the mobile devices fall within the age group.

In another embodiment of the present invention, a system for exchanging communications between mobile devices in a network is provided. The system has a network with a first mobile device and a second mobile device connected to the network. The system has a content provider connected to the network. The content provider has a database of digital media files wherein each digital media file has metadata. The system also has a plurality of rendezvous points wherein each rendezvous point is an online location accessible to the first mobile device and the second mobile device. One of the rendezvous points of the plurality of rendezvous points is assigned to each digital media file in the database. A first rendezvous point is assigned to a first media file having first metadata. The system further has a uniform resource locator. The uniform resource locator is inserted into the metadata of each digital media file in the database. Each uniform resource locator identifies the online location of the rendezvous point assigned to the digital media file. A first uniform resource locator which identifies the first rendezvous point is inserted into the first metadata of the first media file. The content provider transmits the first media file and the first metadata to the first mobile device and to the second mobile device via the network. The first mobile device and the second mobile device use the first uniform resource locator to connect to the online location of the first rendezvous point, and the first mobile device and the second mobile device exchange communications via the first rendezvous point while consuming the first media file.

In an embodiment of the invention, the system has an electronic program guide which identifies the digital media files and which also indicates the availability of the rendezvous points which correspond to the digital media files. The content provider provides the electronic program guide to the first mobile device and the second mobile device.

It is, therefore, an advantage of the present invention to provide a system and a method for creating multimedia rendezvous points for mobile devices.

Another advantage of the present invention is to provide a system and a method for creating multimedia rendezvous points for mobile devices which access digital media from a database for consumption of the digital media via the mobile devices.

An additional advantage of the present invention is to provide a system and a method for creating multimedia rendezvous points for mobile devices which may provide an electronic program guide of a content provider for selecting digital media and/or for accessing a rendezvous identification of the digital media.

Yet another advantage of the present invention is to provide a system and a method for creating multimedia rendezvous points for mobile devices which may access and/or may identify a rendezvous identification from a server over a data communication network.

A further advantage of the present invention is to provide a system and a method for creating multimedia rendezvous points for mobile devices which may access a multimedia rendezvous point for digital media via a rendezvous identification for the digital media and/or a data communication network.

Moreover, an advantage of the present invention is to provide a system and a method for creating multimedia rendezvous points for mobile devices which may transmit communications between the mobile devices connected to a multimedia rendezvous point for digital data via a data communication network.

Another advantage of the present invention is to provide a system and a method for creating multimedia rendezvous points for mobile devices which may transmit communications between the mobile devices connected to a multimedia rendezvous point for digital media as the mobile devices consume and/or view the digital media.

Yet another advantage of the present invention is to provide a system and a method for creating multimedia rendezvous points for mobile devices which allows users of the mobile devices to transmit communications to other mobile devices to share an experience of consuming and/or of viewing digital media with other users.

Another advantage of the present invention is to provide a system and a method for creating multimedia rendezvous points for mobile devices which may allow users of the mobile devices to share an experience of consuming and/or of view digital media with other users during consumption of the digital media.

A still further advantage of the present invention is to provide a system and a method for creating multimedia rendezvous points for mobile devices which may provide subgroups within the multimedia rendezvous points based on attributes of the mobile devices, of users of the mobile devices, of digital media, of an experience of the digital media and/or the like.

Moreover, an advantage of the present invention is to provide a system and a method for creating multimedia rendezvous points for mobile devices which may transmit advertisements to the mobile devices at a multimedia rendezvous point and/or within a subgroup of the multimedia rendezvous point.

And, another advantage of the present invention is to provide a system and a method for creating multimedia rendezvous points for mobile devices which may allow a user of a mobile device to create a private rendezvous identification for accessing a private multimedia rendezvous point and/or a private subgroup within a multimedia rendezvous point.

It is, therefore, another advantage of the present invention to provide a system and a method for exchanging communications between mobile devices which may allow transmitting advertising media associated with a subgroup to the mobile devices connected to the subgroup prior to, during or after consumption of the media file by the user.

An additional advantage of the present invention is to provide a system and a method for exchanging communications between mobile devices which may allow inserting a first uniform resource locator (URL) into the first metadata of the first media file wherein the first uniform resource locator identifies the online location of the first rendezvous point.

Another advantage of the present invention is to provide a system and a method for exchanging communications between mobile devices which may allow a subgroup associated with an age group wherein mobile devices are connected to the subgroup based on whether the users of the mobile devices fall within the age group.

A further advantage of the present invention is to provide a system and a method for exchanging communications between mobile devices which may allow a subgroup to be created by any user of a mobile device.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system for creating multimedia rendezvous points for mobile devices in an embodiment of the present invention.

FIG. 2 illustrates a black box diagram of a system for creating multimedia rendezvous points for mobile devices in an embodiment of the present invention.

FIG. 3 illustrates a flowchart of a method for creating multimedia rendezvous points for mobile devices in an embodiment of the present invention.

FIG. 4 illustrates a flowchart of a method for creating multimedia rendezvous points for mobile devices in an embodiment of the present invention.

### DETAILED DESCRIPTION OF THE PREFERRED EMBODIMENTS

The present invention generally relates to a system and a method for creating multimedia rendezvous points for mobile devices. More specifically, the present invention relates to a system and a method for creating multimedia rendezvous points for mobile devices which may provide access to electronic program guide information of a content provider and/or digital media. The mobile devices may connect to the electronic program guide for selecting and/or for accessing digital media and/or a rendezvous identification for the digital media. In an embodiment, the mobile device may connect to a server via a data communication network for accessing and/or for identifying the rendezvous identification for the digital media. The system and the method may allow the mobile devices to consume the digital media and/or to connect to a multimedia rendezvous point for the digital media via the rendezvous identification. The mobile devices connected to the multimedia rendezvous point may connect to each other for transmitting communications during consumption and/or viewing of the digital media. As a result, users of the mobile devices may share an experience of consuming and/or of viewing the digital media via the communications as the mobile devices may be consuming and/or may be viewing the digital media.

The multimedia rendezvous point may have one or more subgroups which may be based on attributes of the users of the mobile devices, the mobile devices, the digital media, the experience of the digital media and/or the like. The users of the mobile devices may select to join, may be invited to join and/or may be assigned to one or more subgroups within the multimedia rendezvous point for communicating with members of the subgroup during consumption of the digital media. A user of a mobile device may create a private rendezvous identification for accessing and/or for identifying a private rendezvous point and/or a private subgroup of the rendezvous point.

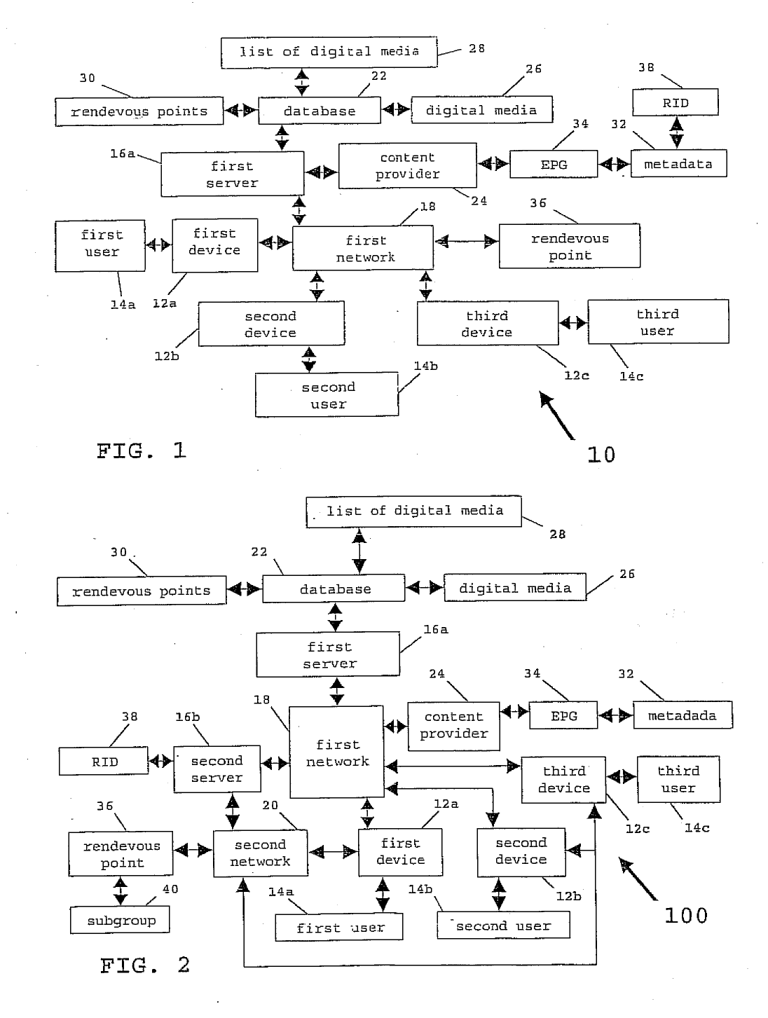

Referring now to the drawings wherein like numerals refer to like parts, FIGS. 1 and 2 illustrate systems 10, 100, respectively, which may have a first device 12a and/or a second device 12b (collectively known hereafter as “the devices 12a, 12b”) which may be connected to and/or may be in communication with a first data communication network 18 (hereinafter “the first network 18”). In an embodiment, the system 100 may have the devices 12a, 12b and/or a third device 12c (collectively known hereinafter as “the devices 12a-12c”) which may be connected to and/or may be in communication with the first network 18 A first user 14a, a second user 14b and/or a third user 14c (collectively known hereafter as “the users 14a-14c”) may access the first network 18 via the devices 12a-12c, respectively. The users 14a-14c may communicate with each other via the devices 12a-12c, respectively, over the first network 18. The present invention should not be deemed as limited to a specific number of devices and/or users which may access and/or may utilize the systems 10, 100.

The systems 10, 100 may have a first server 16a which may be connected to and/or may be accessed by the first network 18. As shown in FIG. 2, the system 100 may have a second server 16b which may be connected to and/or may be accessed by the first network 18. The devices 12a-12c may connect to, may access and/or may be in communication with the first server 16a and/or the second server 16b (collectively known hereinafter as “the servers 16a, 16b”) via the first network 18. As shown in FIG. 2, the system 100 may have a second data communication network 20 (hereinafter “the second network 20”) which may connect to and/or may be in communication with the devices 12a-12c and/or the second server 16b. The devices 12a-12c may connect to, may access and/or may be in communication with the second server 16b via the second network 20. As a result, the users 14a-14c may access and/or may be in communication with the servers 16a, 16b via the devices 12a-12c, respectively, over the first network 18 and/or the second network 20 (collectively known hereinafter as “the networks 18, 20”).

In an embodiment, the networks 18, 20 may be a fixed network, such as, for example, a cabled network, a permanent network and/or the like. In an embodiment, the networks 18, 20 may be a temporary network, such as, for example, a modem network, a null modem network and/or the like. In an embodiment, the networks 18, 20 may be, for example, a personal area network, a local area network, a campus area network, a metropolitan area network, a wide area network and/or the like. In an embodiment, the networks 18, 20 may be a wireless network, such as, for example, a wireless metropolitan area network, a wireless local area network, a wireless personal area network, a global standard network, a personal communication system network, a pager-based service network, a general packet radio service, a universal mobile telephone service network, a radio access network and/or the like. The present invention should not be limited to a specific embodiment of the networks 18, 20. It should be understood that the networks 18, 20 may be any network capable of transferring and/or of transmitting multimedia and/or digital media 26 as known to one having ordinary skill in the art.

The systems 10, 100 may have a database 22 which may be connected to and/or may be accessed by the first server 16a. As a result, the database 22 may be connected to and/or may be accessible from the first network 18 via the first server 16a. A content provider 24 may be connected to and/or may be accessible by the first server 16a. As a result, the content provider 24 may be connected to and/or may be accessible from the first network 18 via the first server 16a. The content provider 24 may be, for example, an electronic source providing program information of the digital media 26 stored within the database 22. In an embodiment, the content provider may be, for example, a broadcaster, a third party content website, an electronic fee from a periodical and/or a medium which may provide the program information to subscribers. The devices 12a-12c may be connected to, may access and/or may be in communication with the database 22 and/or the content provider 24 via the first server 16a and/or the first network 18. As a result, the users 14a-14c may access and/or may be in communication with the database 22 and/or the content server 24 via the first server 16a, the first network 18 and/or the devices 12a-12c, respectively.

The database 22 and/or the content server 24 may be local or may be remote with respect to the first server 16a. The second server 16b may be local or may be remote with respect to the first server 16a, the devices 12a-12c, the database 22 and/or the content provider 24 as shown in FIG. 2. The first device 12a may be local or may be remote with respect to the second device 12b and/or the third device 12c. The third device 12c may be local and/or may be remote with respect to the first device 12a and/or the second device 12b (collectively known hereinafter as “the devices 12a, 12b”).

In an embodiment, the devices 12a-12c may be a handheld mobile device, for example, a 4G mobile device, a 3G mobile device, an internet protocol (hereinafter “IP”) video cellular telephone, an ALL-IP electronic device, an internet radio receiver, a digital video disc player, a satellite radio receiver, a portable digital audio player, a portable digital video player, an information appliance, a personal communicator, a handheld game console, an ultra-mobile personal computer and/or a personal video recorder. Further, the devices 12a-12c may be a digital media device, such as, a personal computer, a laptop computer, a media player, a game console, a set top box, a gateway, a portable media device, a smart phone, a mobile phone, personal digital assistant and/or the like. In an embodiment, the devices 12a-12c may be, for example, a limited data mobile device, a basic data mobile device or a enhanced data mobile device. The present invention should not be deemed as limited to a specific embodiment of the devices 12a-12c. It should be understood that the devices 12a-12c may be any digital media device and/or any handheld mobile device capable of accessing, of displaying, of rendering and/or of consuming digital media as known to one of ordinary skill in the art.

The database 22 may have, may contain and/or may store the digital media 26, a list of digital media 28 and/or rendezvous points 30 as shown in FIG. 1. The digital media 26 may be digital media files, such as, for example, audio signals, still images, video frames, data feeds, data streams, program guides, text information, musical compositions, radio programs, audio books, audio programs, cable television programs, satellite television programs, public access programs, motion pictures, animated works, music videos, animated works, video programs, video games and/or soundtracks and/or video tracks of audiovisual works. In an embodiment, the audiovisual works may be dramatic works, film scores, operas, performances, concerts, plays, operettas, ballets, musicals, circus acts, buskings and/or the like.

The digital media 26 may be data for the digital media files, a subset of the data for the digital media files or may have a pointer or a uniform resource locator (hereinafter “URL”) to access and/or to obtain the digital media files and/or the digital media 26 from the database 22. For example, the digital media 26 for a live television broadcast may contain data, such as, for example, a date, a time, a length of the digital media file and/or a name. The digital video file and/or the digital media 26 may have a network location to access, to receive, to download and/or to stream the digital media files and/or the digital media 26. The present invention should not be deemed as limited to specific embodiments of the digital media files and/or the digital media 26. It should be understood that the data, the digital media 26 and/or the digital media files may be any data and/or any digital media file, respectively, as known to one of ordinary skill in the art. The present invention should not be deemed as limited to a specific number of digital media files and/or a specific amount of data which may be stored within the database 22 in the systems 10, 100.

The digital media 26 which may be stored in the database 22 may have metadata 32 for the digital media 26. The metadata for the digital media 26 may be, for example, a communication and/or information which may be associated with, may relate to and/or may correspond to the digital media 26, the list of digital media 28 and/or the rendezvous points 30. The metadata 32 may be stored within the database 22 and/or by the content provider 24. The communication and/or the information of the digital media 26 may be, for example, text, a graphic, a URL, a broadcast channel, a comment, a note, a review, a correspondence, a commentary, a message, a notice, a bulletin, a memorandum, and/or the like. It should be understood that the communication and/or the information of the metadata 32 may be any communication and/or any information as known to one of ordinary skill in the art.

The content provider 24 and/or the first server 16a may have an electronic program guide application 34 (hereinafter “the EPG 34”). In an embodiment, the EPG 34 may be, for example, an interactive program guide application. The EPG 34 may search, may locate, may identify, may navigate, may search and/or may select the digital media 26, the list of digital media 28, the rendezvous points 30 and/or metadata 32 within the database 22. The EPG 34 and/or the metadata 32 may identify and/or may describe information relating to, associated with and/or indicative the digital media 26. The information of the digital media 26 which may be displayed and/or may be accessed via the EPG 34 and/or the metadata 32 may be, for example, a title, a name of an actor and/or a director, a synopsis, a summary, a year of production, a channel name, a program start time, a genre, an artist, a title of an album and/or a track and/or the like. It should be understood that the information which may be displayed and/or may be accessed via the EPG 34 and/or the metadata 32 may be any information as known to one of ordinary skill in the art.

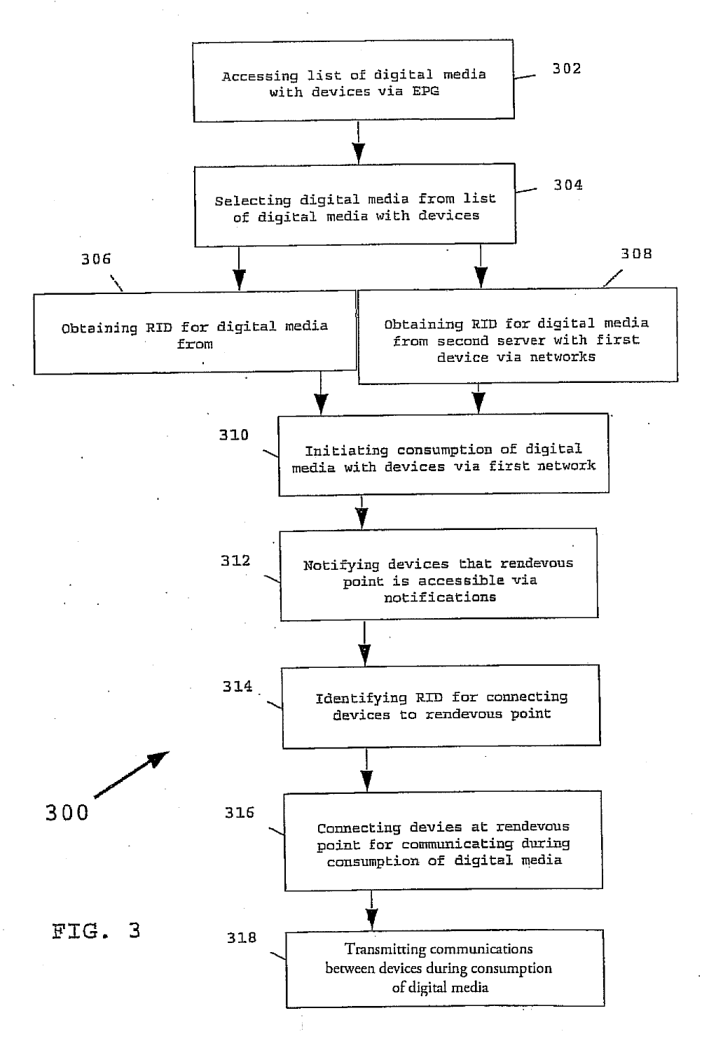

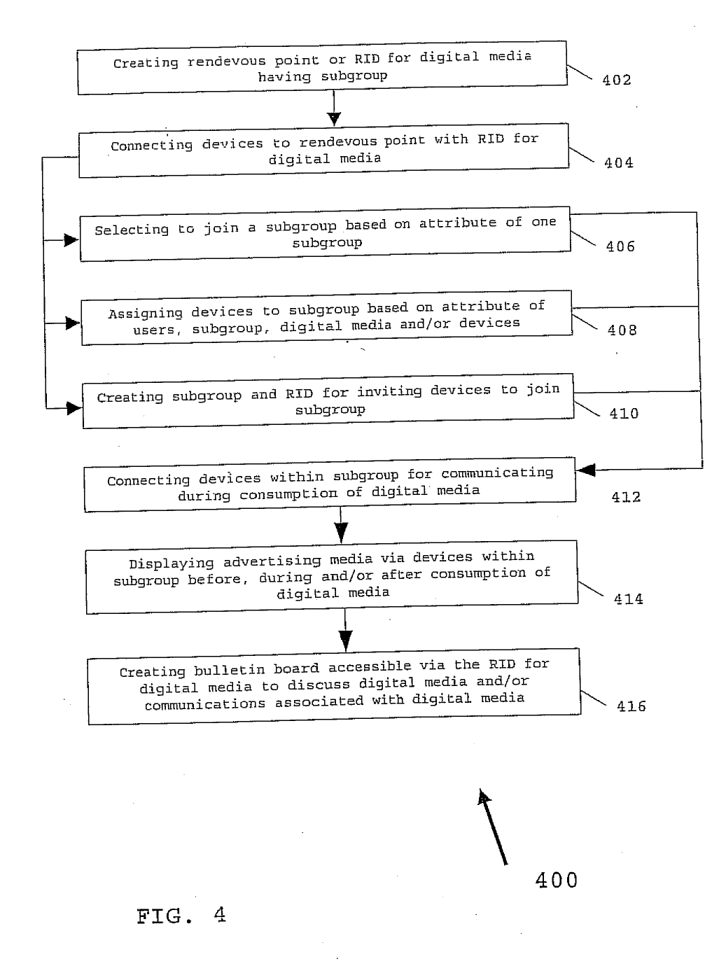

FIG. 3 illustrates a flowchart of a method 300 for creating the rendezvous points 30 for the devices 12a-12c. The guide application may have a graphical user interface (not shown in the figures) for displaying, for selecting, for navigating, for search and/or for locating the digital media 26, the list of digital media files 28, the rendezvous points 30 and/or the metadata 32 which may be availability to the devices 12a-12c. The graphical user interface and/or the EPG 34 may be accessed and/or may be received by the devices 12a-12c via the first server 16a and/or the content provider 24 via the first network 18. The devices 12a-12c may display the EPG 34 and/or the graphical user interface to indicate and/or to display the digital media 26 and/or the list of digital media 28 which may be available to, may be accessible by, may be receivable by and/or may be consumable by the devices 12a-12c. The present invention should not be deemed as limited to a specific embodiment of the EPG 34 in the systems 10, 100. The digital media 26 which may be available for consumption by the devices 12a-12cb may be displayed to the users 14a-14c in the list of digital media 28 via EPG 34 and/or the devices 12a-12c, respectively, as shown at step 302. The users 14a-14c may select, may choose and/or may access the digital media 26 from the list of the digital media 28 via the EPG 34 and/or the devices 12a-12c as shown at step 304.

The digital media 26 stored within the database 22 may have and/or may be associated with a rendezvous point 36 which may correspond to the digital media 26. The rendezvous point 36 for each digital media may be assigned to each digital media 26 and/or may be stored within the database 22. The rendezvous point 36 may be assigned, may be identified by, may be associated with a rendezvous identification 38 (hereinafter “the RID 38”). The servers 16a, 16b and/or the content provider 24 may assign the RID 38 to the rendezvous point 36. In an embodiment, the RID 38 for the rendezvous point 36 may be an online location, such as, for example, an Internet address, a uniform resource identifier, a uniform resource locator, a alphanumeric code, a session initiation protocol and/or the like. The RID 38 may be accessed and/or may be indicative of the online location of the rendezvous point 36 for the digital media 26. The present invention should not be deemed as limited to a specific embodiment of the online location of the RID 38.

The RID 38 of the rendezvous point 36 for the digital media 26 may be embedded into, may be inserted into and/or may be located within the metadata 32 of the digital media 26 as shown in FIG. 1. As a result, the devices 12a-12c may access, may identify and/or may receive the RID 38 of the rendezvous point 36 for the digital media 26 with the metadata of the digital media 26 via the EPG 34 and/or the graphical user interface of the EPG 34 as shown at step 306 in FIG. 3. The first server 16a may stream, may broadcast, may transmit and/or may feed the EPG 34 having the metadata 32 and/or the RID 38 of the rendezvous point 36 to the devices 12a-12c via the first network 18. As a result, the devices 12a, 12b may identify and/or may locate the rendezvous point 36 for the digital media 26 via the online location of the rendezvous point 36 and/or the RID 38.

In an embodiment, the devices 12a-12c may be programmed with software which may read and/or may decode the metadata 32 for the digital media 26 received from the first server 16a via the EPG 34 over the first network 18. The devices 12a-12c may transmit, may communicate and/or may send a portion of the metadata 32 for the digital media 26 to the second server 16b via the networks 18, 20 as shown in FIG. 2. The RID 38 of the rendezvous point 36 for the digital media 26 may be stored by and/or may be accessible by the second server 16b. The second server 16b may receive the portion of the metadata 32 for the digital media 26 to identify, to access and/or match the RID 38 of the rendezvous point 36 for the digital media 26. The second server 16b may transmit the RID 38 of the rendezvous point 36 for the digital media 26 to the devices 12a-12c via the networks 18, 20. As a result, the devices 12a-12c may access, may identify and/or may receive the RID 38 of the rendezvous point 36 for the digital media 26 via second server 16b and/or the networks 18, 20 as shown at step 308 in FIG. 3.

The devices 12a-12c may be remotely connected to the first server 16a, the database 22 and/or the content provider 24 via the first network 18. The devices 12a-12c may access, may identify and/or may render the list of digital media 28, the metadata 32 and/or the rendezvous points 30 to the users 14a-14c, respectively, via the EPG 34 and/or the first network 18. The users 14a-14c may view the EPG 34 to determine and/or to identify the digital media 26, the metadata 32 of the digital media 26, the list of digital media 28 and/or the rendezvous points 30 via the devices 14a-14c. The users 14a-14c may select and/or may identify the digital media 26 and/or the metadata 32 of the digital media 26 from the list of digital media 28 with the EPG 34 via the devices 12a-12c, respectively.

The first server 16a and/or the content provider 24 may broadcast, may stream, may transfer and/or may transmit the digital media 26 and/or the metadata 32 of the digital media 26 to the devices 12a-12c via the first network 18. The devices 12a-12c may receive the RID 38 of the rendezvous point 36 for the digital media 26 from the first server 16a or the second server 16b via the networks 18, 20. As a result, the devices 12a-12c may locate and/or may identify the online location of the rendezvous point 36 for the digital media 26 from the RID 38. The devices 12a-12c may initiate and/or may begin viewing, consuming and/or rendering of the digital media 26 as shown at step 310.

An on-screen notification may be displayed by the devices 12a-12c to the users 14a-14c, respectively, to invite the users 14a-14c to join and/or to access the rendezvous point 36 for the digital media 26. As a result, the users 14a-14c may be notified by the on-screen notification that the rendezvous point 36 for the digital media 26 may be accessed by the devices 12a-12c, respectively, during consumption of and/or viewing of the digital media 26 as shown at step 312. The on-screen notification may be, for example, a pop-up window, a pop-under window, a transparent overlay and/or the like. In an embodiment, the on-screen notification may be displayed by the devices 12a-12c prior to consumption of the digital media 26 by the devices 12a-12c. In an embodiment, the on-screen notification may be displayed adjacent to, on top and/or underneath the digital media 26 on the display (not shown in the drawings) of the devices 12a-12c. It should be understood that the on-screen notification may be any on-screen notification which may be displayed by the devices 12a-12c as known to one of ordinary skill in the art.

The users 14a-14c may select and/or may choose to join and/or to access the rendezvous point 36 for the digital media 26 via the on-screen notification, the EPG 34 and/or the devices 12a-12c, respectively. As a result, the devices 12a-12c may access and/or may identify the RID 38 of the rendezvous point 36 for the digital media 26 to access and/or to connect to the rendezvous point 36 via the networks 18, 20 as shown at step 314. The devices 12a-12c may connect to the rendezvous point 36 for the digital media 26 via the networks 18, 20 without disconnecting the devices 12a-12c from the first server 16a as shown at step 316. Moreover, the devices 12a-12c may connect to the rendezvous point 36 without disrupting a viewing, a consuming and/or a rendering of the digital media 26 by the devices 12a-12c. The present invention should not be deemed as limited to a specific number of users and/or devices which may access and/or may consume the digital media 26 and/or which may join and/or may access the rendezvous point 36 of the digital media 26 in the systems 10, 100.

The digital media 26 may be rendered, may be displayed, may be viewed, may be consumed and/or may be reproduced to the users 14a, 14b via the devices 12a-12c, respectively. The devices 12a-12c may be connected to each other at the rendezvous point for the digital media 26 during consumption of, viewing of and/or rendering of the digital media 26. The users 14a-14c may perceive, may observe and/or may witness an experience of the digital media 26 during consumption of, viewing of and/or rending of the digital media 26 to the users 14a-14c via the devices 12a-12c, respectively. The experience of the digital media 26 by the users 14a-14c may occur and/or may pass with the devices 12a-12c connected to the rendezvous point 36 for the digital media 26. As a result, the users 14a-14c may share the experience of the digital media 26 via the rendezvous point 36 and/or the devices 12a-12c, respectively.

The users 14a-14c may be connected via the rendezvous point 36 and/or the devices 12a-12c, respectively, during consumption and/or viewing of the digital media 26 for transmitting communications between the devices 12a-12c. In an embodiment, one of the communications may be, for example, a text communication, a graphical communication, an audio communication, an audiovisual communication, a multimedia communication and/or the like. In an embodiment, the communications may be transmitted between the devices 12a-12c via, for example, text-based technologies, voice-based technologies, session-based technologies, video-based technologies and/or the like. The text-based technologies may be, for example, a short message service, an instant message service, a multimedia messaging service, a mobile instant message service, a mobile electronic mail service, an enhanced messaging service and/or the like. The voice-based technologies may be, for example, a voice-over internet protocol service, an internet telephony service, a broadband telephony service, a peer-to-peer internet telephony service and/or the like. The session-based technologies may be, for example, session initiation protocol service and/or the like. The video-based technologies may be, for example, a real-time two-way video conference and/or the like. It should be understood that the communications between the devices 12a-12c may any type of communications transmittable via the networks 18, 20 as known to one of ordinary skill in the art.

In an embodiment, the graphical communication, may be, for example, visual icons which may indicate and/or may identify feelings, emoticons, avatars, reactions and/or ratings which may relate to, may describe and/or may be indicative of the experience of consuming and/or of viewing the digital media 26. The audio communication may be, for example, a real-time voice, voice messages and/or sound effects. The audiovisual communication or a multimedia communication may be a video conference which may contain one or more of the above-identified communications. The communications may be integrated, may be presented and/or may be stored as part of or an enhancement to consumption of and/or viewing of the digital media 26 via the devices 12a-12c. The users 14a-14c may access, may review, may revise and/or may replay the communications associated with and/or corresponding to the experience of the digital media 26 at a time period after or in a future with respect to the experience of consuming and/or of viewing the digital media 26.

Communications may be transmitted to and/or may be sent between the devices 12a-12c via the rendezvous point 36 over the networks 18, 20 during consumption of and/or viewing of the digital media 26 as shown at step 318. As a result, the users 14a-14c may transmit, may receive, may view and may display the communications via the devices 12a-12c, respectively during consumption of and/or viewing of the digital media 26. Each communication may relate to, may be associated with and/or may correspond to the experience of consuming and/or viewing the digital media 26 by the users 14a-14c via the devices 12a-12c. As a result, the users 14a-14c may share the experience of consuming and/or of viewing the digital media 26 via the communications and/or the devices 12a-12c, respectively, during consumption of and/or viewing of the digital media 26.

The metadata 32 of the digital media 26 and/or the digital media 26 may be transmitted to and/or may be received by the devices 12a-12c from the first server 16a over the networks 18, 20 via a standard communication protocol. The communications may be transmitted, may be received and/or may be shared between the devices 12a-12c over the networks 18, 20 via the standard communication protocol. The protocol may be a data networking protocol, such as FTP, HTTP, UDP, TCP, IP, IMAP, IRC, NNTP, POP3, SIP, MMS, SMS, XMPP, MTP, SMTP, SNMP, SSH and/or the like. The present invention should not be limited to a specific embodiment of a data networking protocol.

As illustrated in FIG. 2, the content provider 24 and/or the first server 16a may create the rendezvous point 36 and/or the RID 38 having at least one subgroup 40. FIG. 4 illustrates a flowchart of a method of creating the rendezvous point 36 and/or the RID 38 which may have the subgroup 40. The content provider 24 and/or the first server 16 may create the RID 38 for the rendezvous point 36 which may have the subgroup 40 as shown at step 402. The RID 38 for the rendezvous point 36 of the digital media 26 may identify, may be indicative of, may describe, may be associated with, may link to and/or may correspond to the online location of the subgroup 40 within the rendezvous point 36. The RID 38 may be stored within the database 22 for accessing by the devices 12a-12c to join the subgroup 40 of the rendezvous point 36.

The subgroup 40 may be defined by, may be based on, may correspond to and/or may identify an attribute of at least one of the users 14a-14c, of at least one of the devices 12a-12c, of the digital media 26 and/or of the content provider 24. The attribute of the users 12a-12c may relate to, may be based on and/or may be associated with, for example, biographical information, a personal preference, a personal interest, a social interest, a cultural interest, a religious affiliation, a political affiliation, an educational level, a geographical location, a language, a family orientation, a period of time, a sports team, a music performer, an entertainer, a community value, an age group and/or the like. The attribute of the devices 12a-12c may relate to, may be based on and/or may be associated with, for example, a type of the devices 12a-12c, an operating format of the devices 12a-12c, a displaying capability of the devices 12a-12c and/or the like. The attribute of the digital media 26 may relate to, may be based on and/or may be associated with the experience of consuming and/or viewing the digital media 26, a type of digital media file of the digital media 26, an audiovisual work displayed via the digital media 26 and/or the like. The present invention should not be deemed as limited to a specific embodiment of the interest and/or the attribute of the users 14a-14c, of the devices 12a-12c and/or of the digital media 26 for the subgroup 40.

The users 14a-14c may select to access, to consume and/or to view the digital media 26 from the list of digital media 28 which may be displayed on the devices 12a-12c, respectively, via the EPG 34 and/or the graphical user interface of the EPG 34. The devices 12a-12c may access, may obtain and/or may identify the RID 38 for the rendezvous point 36 of the digital media 26 via the metadata 32 of the digital media 26 and/or the second server 16b. The devices 12a-12c may initiate and/or may begin consumption and/or viewing of the digital media 26 via the first server 16a and/or the networks 18, 20.

The on-screen notification may notify and/or may indicate to the users 14a-14c that the rendezvous point 36 for the digital media 26 may be accessed by the devices 12a-12c, respectively, during consumption of and/or viewing of the digital media 26. The users 14a-14c may select and/or may choose to join and/or to access the rendezvous point 36 for the digital media 26 via the on-screen notification, the EPG 34 and/or the devices 12a-12c, respectively. As a result, the devices 12a-12c may access the RID 38 of the rendezvous point 36 and/or may connect to the rendezvous point 36 via the networks 18, 20 without disconnecting the devices 12a-12c from the first server 16a as shown at step 404.

The on-screen notification may notify and/or may indicate to the users 14a-14c that the subgroup 40 of the rendezvous point 36 and/or the RIP 38 may be accessed by the devices 12a-12c, respectively, during the consumption and/or viewing of the digital media 26. The on-screen notification displayed by the devices 12a-12c may identify that the subgroup 40 may be based on, may be associated with and/or may correspond to the attribute of the users 12a-12c, of the device 14a-14c, of the digital media 26 and/or the content provider 24. The users 14a-14c may identify the attribute of the subgroup 40 to determine whether to join and/or to access the subgroup 40 during consumption and/or viewing of the digital media 26. The attributes of the subgroup 40 may be similar to, may match and/or may resemble the attributes of the users 12a-12c. As a result, one or more of the users 12a-12c may select to join and/or to access the subgroup 40 via the RID 38 during consumption and/or viewing of the digital media 26 as shown at step 406. Alternatively, one or more of users the 14a-14c may determine not to join and/or to access the subgroup 40 during consumption and/or viewing of the digital media 26 based on the attributes of the subgroup 40.

For example, the users 14a-14c may have selected to consume and/or to view the digital media 26 which may be a political debate. The users 14a, 14b may be members of a first political party which may be participating in the political debate. The third user 14c may be a member of a second political party which may be participating in the political debate. The subgroup 40 may be identified with and/or may correspond to the first political party participating in the debate. The users 14a, 14b may select to join and/or to access the subgroup 40 during the political debate based on the attribute that the subgroup 40 associated with the first political party. The third 14c user may select not to join and/or to access the subgroup 40 during political debate based on the attribute that the subgroup 40 is associated with the first political party.

In another example, the users 14a-14c may have selected to consume and/or to view the digital media 26 which may be a sporting event. The users 14a, 14b may be supporters of a first team which may be participating in the sporting event. The third user 14c may be a supporter of a second team which may be participating in the sporting event. The subgroup 40 may be identified with and/or have the attribute which may be associated with the first team participating in the sporting event. The users 14a, 14b may select to join and/or to access the subgroup 40 during the sporting event based on the attribute that the subgroup 40 associated with the first team. The third user may select not to join and/or to access the subgroup 40 during sporting event based on the attribute that the subgroup 40 is associated with the first team.

In an embodiment, one or more devices 12a-12c may be assigned to join and/or to access the subgroup 40 based on the attribute of the users 14a-14c, of the subgroup 40, of the digital media 26 and/or of the devices 12a-12c as shown at step 408. The devices 12a-12c, the users 14a-14c, the server 16a, 16b, the RID 38 and/or the content provider may assign one or more of the devices to join and/or to access the subgroup 40 during consumption of the digital media 26. For example, the devices 12a, 12b may be located within a first region and the third devices 12c may be located within a second region. As a result, the servers 16a, 16b, the content provider 24, the RID 38 and/or the devices 12a-12c may assign the devices 12a, 12b to the subgroup 40 based on the attribute that the subgroup 40 may be associated with the first region. In another example, the users 14a-14c may be within an age group and the subgroup 40 may be associated with the age group. As a result, the servers 16a, 16b, the content provider 24, the RID 38 and/or the devices 12a-12c may assign the devices 12a-12c of the users 14a-14c, respectively, to the subgroup 40.

In an embodiment, one or more of the users 14a-14c may create the subgroup 40 and/or the RID 38 for inviting one or more of the devices 12a-12c to join the subgroup 40 during consumption of the digital media 26 as shown at step 410. The RID 38 may identify, may describe and/or may be indicative of the subgroup 40 and/or the attribute of the subgroup 40. The subgroup 40 which may be created by one of the users 12a-12c may be private and/or may be access by invitations. One or more of the users 12a-12c may receive an invitation by the online notification to join the subgroup 40 after initiating consumption of the digital media 26 via the systems 10, 100. The users 12a-12c which may receive the invitation may accept or may reject joining and/or accessing the subgroup 40 during the consumption of the digital media 26.

For example, the users 14a, 14b may be members of an affiliation, such as, for example, a family, a network of friends, a social club, a fraternity, an organization and/or the like. The first user 14a may create the subgroup 40 with the RID 38 which may have the attribute of being associated with the affiliation. The first users 14a may invite the second user 14b to join the subgroup 40 during consumption and/or viewing of the digital media 26 via the RID 38 of the digital media 32. After initiating consumption of the digital media 26 and connecting to the rendezvous point 36 via the RID 38, the second device 12b may display the invitation from the first user 12a to join the subgroup 40 during consumption of the digital media 26. The second user 14b may select to join or to not join the subgroup 40 with the first user 14a via the second device 12b.

The devices 12a, 12b may be connected to the rendezvous point 36 for the digital media 26 during the consumption and/or viewing of the digital media 26 via the RID 38. The users 14a, 14b may select to join and/or to access the subgroup 40 based on the attribute of the subgroup 40 for communicating during consumption of the digital media 26. As a result, the devices 12a, 12b may be connected within the subgroup 40 for communicating during the consumption of the digital media as shown in step 412. The devices 12a, 12b may be connected within the subgroup 40 without disrupting a viewing, a consuming and/or a rendering of the digital media 26 by the devices 12a, 12b. The users 14a, 14b may transmit communications via the devices 12a, 12b, respectively, during the consumption and/or viewing of the digital media 26. The communications transmitted between the devices 12a, 12b may be related to, may describe, may be indicative of and/or may be associated with the experience of consuming the digital media 26. As a result, the users 14a, 14b may share the experience of the digital media 26 via the devices 12a, 12b which may be connected within the subgroup 40. The advertising media may be displayed to, may be consumed by and/or may be experienced by the users 14a-14c prior to, during and/or after consumption and/or viewing of the digital media via the device 12a-12c, respectively.

The database 22 may store advertising media for transmitting to the devices 12a-12c at the rendezvous point 36 and/or within the subgroup 40 via the networks 18, 20. The first server 16a may transmit the advertising media to one or more of the devices 12a-12c which may have received a RID 26 of the digital media 26. In an embodiment, the content provider 24 may transmit the advertising media to the devices 12a-12c at the rendezvous point 36 and/or within the subgroup 40 via the networks 18, 20. In an embodiment, the digital media 26 may contain the advertising media which may be transmitted to the devices 12a-12c at the rendezvous point 36 and/or within the subgroup 40 via the networks 18, 20. The advertising media which may be received by the devices 12a-12c may be based on and/or may be indicative of the attribute of the devices 12a-12c, of the users 14a-14c, of the digital media 26 and/or of the subgroup 40. The advertising media may be displayed to and/or may be experienced by the users 14a-14c prior to, during and/or after consumption and/or viewing of the digital media 26 via the device 12a-12c, respectively, as shown at step 414.

The advertising media may relate to, may be associated with and/or may correspond to the media provider (not shown in the figures). The advertising media may be, for example, a commercial, an advertisement, an audio transmission, a video, an interview, a commentary, a documentary and/or the like. In an embodiment, the advertising media may relate to, may be associated with and/or may correspond to an entity, such as, for example, a corporate entity, a marketing agency, a media distributor, a consumer products producer, an advertising agency, a manufacturer, a government agency, a travel corporation, an entertainment corporation and/or the like. The present invention should not be limited to a specific embodiment of the entity associated with the advertising media. It should be understood that the advertising media may be any type of advertising media as known to one of ordinary skill in the art.

After the digital media 26 is consumed by the devices 12a-12c, the rendezvous point 36 and/or the RID 38 may remain permanently or temporarily accessible by the devices 12a-12c. The rendezvous point 36 and/or the RID 38 may be operate as an online bulletin board system to facilitate and/or to allow discussions related to and/or associated to the digital media 26, the communications between the devices 12a-12c during consumption of the digital media 26 and/or users 14a-14c. The online bulletin board system may provide an online forum and/or a message board for the users 14a-14c to transmit and/or to post communications, messages and/or data. The communications associated with and/or relating to the experience of consuming the digital media 26 by the users 14a-14c may be accessed and/or may be viewed by the devices 12a-12c, respectively, via the online bulletin board, the rendezvous point 36 and/or the RID 38.

The systems 10, 100 and the methods 300, 400 may create the rendezvous points 30 for the devices 12a-12c. The users 14a-14c may access the first server 16a and/or the content provider 24 to view and/or to access the list of digital media 28 and/or the rendezvous points 30 for the digital media 28 via the devices 14a-14c, respectively. The users 14a-14c may select the digital media 26 from the list of digital media 28 via the devices 12a-12c, respectively. The first server 16a and/or the content provider 24 may transmit the digital media 26 and/or the RID 38 for the rendezvous point 36 of the digital media 26 to the devices 12a-12c. The devices 12a-12c may access the digital media 26 and/or the RID 38 for the rendezvous point 36 via the servers 16a, 16b and/or the networks 18, 20. The devices 12a-12c may connect to the rendezvous point 36 via the networks 18, 20 and/or the RID 38 of the digital media 26 for communicating during consumption of the digital media 26 by the devices 12a-12c. The devices 12a-12c may connect to and/or may communicate with each other at the rendezvous point 36 without disrupting consumption of the digital media 26. The users 14a-14c of the devices 12a-12c, respectively, may share an experience of consuming by transmitting the communications between the devices 12a-12c at the rendezvous point 36 during consumption of the digital media 26. The rendezvous point 36 may have a subgroup 40 which may relate to the attribute of the users 14a-14c, the devices 12a-12c, the digital media 26 and/or the experience of the digital media 26.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A method for exchanging communications between a first mobile device and a second mobile device, the method comprising the steps of:
providing a database of digital media files wherein each digital media file in the database has metadata wherein a content provides the database;
creating a plurality of rendezvous points wherein each of the plurality of rendezvous points is an online location accessible to the first mobile device and the second mobile device;
assigning to each digital media file in the database one of the plurality of rendezvous points wherein a first rendezvous point is assigned to a first media file having first metadata;
inserting a uniform resource locator into the metadata of each digital media file in the database wherein the uniform resource locator identifies the online location of the rendezvous point assigned to the digital media file and further wherein a first uniform resource locator which identifies the first rendezvous point is inserted into the first metadata of the first media file;
transmitting the first media file and the first metadata to the first mobile device wherein the content provider transmits the first media file and the first metadata to the first mobile device;
connecting the first mobile device to the online location of the first rendezvous point wherein the first mobile device uses the first uniform resource locator to connect to the online location of the first rendezvous point wherein the first mobile device is connected to the online location of the first rendezvous point while consuming the first media file;
transmitting the first media file and the first metadata to the second mobile device wherein the content provider transmits the first media file and the first metadata to the second mobile device;
connecting the second mobile device to the online location of the first rendezvous point wherein the second mobile device uses the first uniform resource locator to connect to the online location of the first rendezvous point wherein the second mobile device is connected to the online location of the first rendezvous point while consuming the first media file; and
exchanging communications between the first mobile device and the second mobile device via the first rendezvous point wherein the first mobile device and the second mobile device exchange the communications while consuming the first media file.

2. The method of claim 1 further comprising the step of:
displaying a notification on the first mobile device wherein the notification indicates to a user of the first mobile device that the first rendezvous point is accessible.

3. The method of claim 1 further comprising the step of:
displaying a notification on the first mobile device wherein the notification indicates to a user of the first mobile device that the first rendezvous point is accessible wherein the notification is displayed prior to consumption of the media file by the first mobile device.

4. The method of claim 1 further comprising the step of:
displaying a notification on the first mobile device wherein the notification indicates to a user of the first mobile device that the first rendezvous point is accessible wherein the notification is a pop-up window.

5. The method of claim 1 further comprising the step of:
exchanging a text communication between the first mobile device and the second mobile device via the first rendezvous point wherein the first mobile device and the second mobile device exchange the text communication while consuming the first media file.

6. The method of claim 1 further comprising the step of:
exchanging an audio communication between the first mobile device and the second mobile device via the first rendezvous point wherein the first mobile device and the second mobile device exchange the audio communication while consuming the first media file.

7. The method of claim 1 further comprising the step of:
exchanging a graphical communication between the first mobile device and the second mobile device via the first rendezvous point wherein the first mobile device and the second mobile device exchange the graphical communication while consuming the first media file.

8. method of claim 1 further comprising the step of:
exchanging an audiovisual communication between the first mobile device and the second mobile device via the first rendezvous point wherein the first mobile device and the second mobile device exchange the audiovisual communication while consuming the first media file.

9. The method of claim 1 wherein the communications share the media consumption experience of users of the mobile devices.

10. The method of claim 1 further comprising the steps of:
displaying a notification on the first mobile device wherein the notification indicates the existence of a subgroup of the first rendezvous point to a user of the first mobile device wherein the notification is displayed while the first mobile device is connected to the first rendezvous point; and
presenting an option for the user to connect to the subgroup.

11. A method for exchanging communications between a first mobile device and a second mobile device, the method comprising the steps of:
providing a database of digital media files wherein each digital media file in the database has metadata wherein a content provider provides the database;
creating a first rendezvous point that is an online location accessible to the first mobile device and the second mobile device;
assigning the first rendezvous point to a first media file of the database wherein the first rendezvous point has first metadata;
inserting a first uniform resource locator (URL) into the first metadata of the first media file wherein the first uniform resource locator identifies the online location of the first rendezvous point;
transmitting the first media file and the first metadata to the first mobile device wherein the content provider transmits the first media file and the first metadata to the first mobile device;
connecting the first mobile device to the online location of the first rendezvous point wherein the first mobile device uses the first uniform resource locator to connect to the online location of the first rendezvous point wherein the first mobile device is connected to the online location of the first rendezvous point while consuming the first media file;
connecting the second mobile device to the online location of the first rendezvous point wherein connection of the first mobile device and second mobile device to the first rendezvous point allows the first mobile device and the second mobile device to exchange communications while the first mobile device consumes the first media file;
displaying a notification on the first mobile device wherein the notification indicates to a user of the first mobile device that a subgroup of the first rendezvous point is available;
connecting the first mobile device to the subgroup of the first rendezvous point in response to user input accepted by the first mobile device; and
transmitting a communication wherein the first mobile device transmits the communication while the first mobile device is connected to the subgroup of the first rendezvous point and further wherein the second mobile device receives the communication if the second mobile device is also connected to the subgroup.

12. The method of claim 11 wherein the subgroup is created by a user of the second mobile device.

13. The method of claim 11 wherein the subgroup is based on a first user attribute and further wherein the connection of the first mobile device to the subgroup is based on a user of the first mobile device having the first user attribute.

14. The method of claim 11 further comprising the step of:
transmitting advertising media associated with the subgroup to a mobile device connected to the subgroup and not transmitting the advertising media to a mobile device connected to the first rendezvous point which is not connected to the subgroup.

15. The method of claim 11 further comprising the step of:
transmitting advertising media associated with the subgroup to a mobile device connected to the subgroup prior to consumption of the first media file by a user.

16. The method of claim 11 further comprising the step of:
transmitting advertising media associated with the subgroup to a mobile device connected to the subgroup during consumption of the first media file by a user.

17. The method of claim 11 further comprising the step of:
transmitting advertising media associated with the subgroup to a mobile device connected to the subgroup after consumption of the first media file by a user.

18. The method of claim 11 wherein the subgroup is associated with an age group wherein mobile devices are connected to the subgroup based on whether the users of the mobile devices fall within the age group.

19. A system for exchanging communications between mobile devices in a network, the system comprising:
a network;
a first mobile device connected to the network;
a second mobile device connected to the network;
a content provider connected to the network wherein the content provider has a database of digital media files and wherein each digital media file has metadata;
a plurality of rendezvous points wherein each of the plurality of rendezvous points is an online location accessible to the first mobile device and the second mobile device wherein one of the plurality of rendezvous points is assigned to each digital media file in the database wherein a first rendezvous point is assigned to a first media file having first metadata;
a uniform resource locator inserted into the metadata of each digital media file in the database wherein each uniform resource locator identifies the online location of the rendezvous point assigned to the digital media file and further wherein a first uniform resource locator which identifies the first rendezvous point is inserted into the first metadata of the first media file and wherein the content provider transmits the first media file and the first metadata to the first mobile device and to the second mobile device via the network wherein the first mobile device and the second mobile device use the first uniform resource locator to connect to the online location of the first rendezvous point and further wherein the first mobile device and the second mobile device exchange communications via the first rendezvous point while consuming the first media file.

20. The system of claim 19 further comprising:
an electronic program guide which identifies the digital media files and which further indicates the availability of the rendezvous points which correspond to the digital media files wherein the content provider provides the electronic program guide to the first mobile device and the second mobile device.
